(19) United States
(12) Patent Application Publication
(10) Pub. No.: US 2003/0121605 A1
(43) Pub. Date: Jul. 3, 2003

(54) Process, machine and hot-melt material for bonding textiles

(76) Inventor: Ardenzo Cianchini, Pistoia (IT)

Correspondence Address: MCGLEW & TUTTLE, PC, SCARBOROUGH STATION, SCARBOROUGH, NY, 10510, US

(21) Appl. No.: 10/239,318

(22) PCT Filed: Feb. 26, 2001
(86) PCT No.: PCT/IT01/00090

(51) Int. Cl. B32B 31/20

(52) U.S. Cl. 156/309.6; 156/322; 156/543

(57) ABSTRACT

A very thin hot-melt layer (1X) is supported and carried by one (3) of the two textiles (3, 15), and is heated from the surface opposite that which is in contact with the textile (3) which supports and carries it, until the whole thickness of said layer (1X) is plasticized; the other textile (15) is then brought up to the first, and the two textile (3, 15) are pressed together.

### DESCRIPTION

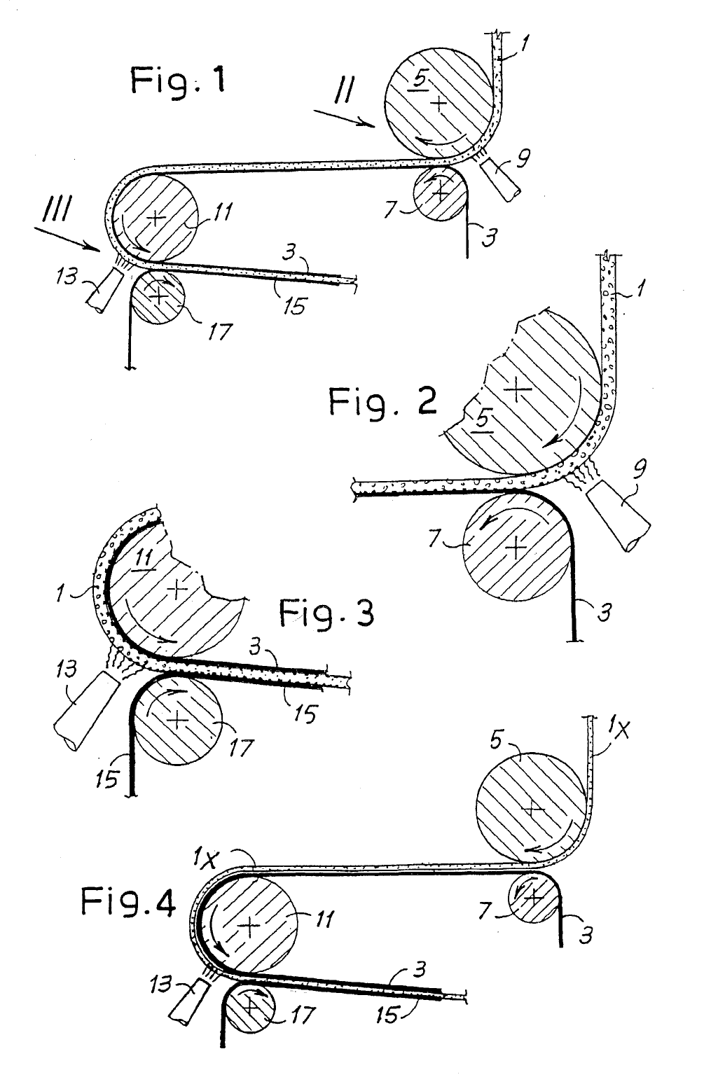

A method of bonding two textiles with an adhesive in the form of a layer of expanded polyurethane (“foam” or equivalent), by a two-stage process, using equipment such as that illustrated in FIGS. 1 to 3, is known. The aforesaid layer 1 and one 3 of the two textiles to be bonded are fed between a cylinder 5 and a roller 7, after a first heating unit 9 has superficially heated the surface of the layer 1 which is to come into contact with the textile 3. The textile 3 with the layer 1 bonded to it is then transferred to a second cylinder 11, against which a second heating unit 13 plasticizes the opposite surface of the layer 1 for the subsequent bonding of the second textile 15, which is carried out in this second stage by means of the passage between the second cylinder 11 and a roller 17 which feeds the second textile 15. With this bonding system, comprising two stages and two surface-plasticizing procedures (particularly those of the flame or hot-air type), a relatively thick layer or sheet of expanded polyurethane or the like is melted to bond two textiles in a sandwich configuration. The resulting product is a relatively rigid textile, produced with a relatively very thick layer of adhesive 1 and with two successive passages across two heating units 9 and 13.

Other equipment can make use of the products of various companies, including modified polyolefin-based films made by Sarna Xiro (D and CH); self-adhesive polymers made by Vegam (I); the Griltex® products made by EMS-Chemie (CH); polyolefins, polyamides and the like made by Bemis (UK); and others. These adhesive films are used as adhesives by the following method: the film is introduced between the two textiles and heat is applied to it through at least one of the textiles until it reaches the necessary temperature for the melting or decomposition of the material, the textiles being bonded by pressing between two cylinders of the calender type. This system can cause damage to the textile subjected to heating (not all textiles can withstand high temperatures), and, in this case also, a relatively rigid double textile is produced. It is not possible to bond textiles which are relatively thick.

The invention avoids the aforementioned problems and achieves other objectives and advantages which will be made clear by the following text.

A first object of the invention is a process for bonding two textiles or similar products with a hot-melt layer (such as those mentioned above), in which a hot-melt layer of very thin expanded polyurethane or one of the films, mentioned above is used; one of the textiles supports and carries the hot-melt layer; said hot-melt layer is heated from the surface opposite the surface in contact with the textile which supports and carries it, until the whole thickness of said layer is plasticized; and the other textile is then brought up to it and the two textiles are pressed together. The heating can be carried out with flame or hot-air heating means or in another way, according to the hot-melt material used and/or other circumstances.

When thin layers of expanded polyurethane or other expanded products are used, this hot melt material can be used in conjunction with other powder, paste or spray-on adhesives, to increase the bonding power and the resistance to peeling. These auxiliary. adhesives can be distributed as follows:

on the hot melt placed on the first textile, before the heating means, which then also act on the adhesive; or

on the surface of the first textile before the hot melt is placed on it, so that the adhesive is heated through the hot melt; or

on the second textile, so that the heating means do not act on the adhesive.

The invention also relates to a machine for bonding two textiles or similar products with a hot-melt layer, which comprises means for bringing together in the cold state a first of the two textile and the very thin hot-melt layer, in such a way that said layer is made to advance together with said textile; heating means which act on said hot-melt layer to plasticize it through its whole thickness, as far as its surface in contact with said first textile; and means for bringing the second textile up to said plasticized hot-melt layer which is in contact with the first textile, and for pressing the two textiles.

Said heating means are positioned in such a way that they act on an advancing cylinder on which is placed the first textile which carries the hot-melt layer, and immediately after said heating means—with respect to the advancing movement—there are means, of the roller or equivalent type, for bringing the second textile up to said plasticized hot-melt layer.

The machine can be of the type with two cylinder-and-roller pairs. In this case a first cylinder and a first roller interact to bring the first textile and the hot-melt layer together in the cold state; the first textile, supporting the hot-melt layer, runs around a second cylinder; the heating means act in the direction of said second cylinder, and a second roller interacts with said second cylinder, to bring the second textile up to the first and to interact with said second cylinder to press the two textiles and bond them.

Alternatively, the machine can comprise a cylinder and a first roller interacting to bring the first textile and the hot-melt layer together in the cold state, the first textile, which supports the hot-melt layer, running around said cylinder; heating means which act in the direction of said cylinder; after said heating means, a second roller interacting with said cylinder to bring the second textile up to the first textile and to press the two textiles and bond them.

If it is necessary to add adhesives to the hot-melt layer, it is possible to provide devices—of a known type—for adding small quantities of adhesive powder and/or paste, which can conveniently settle within the open surface cells of an expanded hot melt (such as expanded polyurethane).

To summarize, the proposed process consists in hot-melting a web or a foam or film sheet of polyester, polyamide or polyurethane and polyethylene, placed on a first of the textiles; and in bringing the second textile up to the first textile to bond them together by pressing between two cylinders of the calender type. Virtually the whole of the thin hot-melt layer such as a sheet of expanded polyurethane—is melted, to bond the two textiles directly in a sandwich configuration. Thus the same result as that of the prior art is achieved with the use of a thickness of hot melt (polyurethane or other) which is approximately half of that used up to the present time, and with only one heating unit.

Thin layers of expanded polyurethane have been used up to the present time not for bonding, but in other fields such as the manufacture of quilts or other products.

The proposed hot-melt adhesive melting process can be used to bond even very heavy textiles, unlike the conventional method of hot calendering, where the higher temperature required to penetrate the textile layer would tend to have adverse effects on the characteristics of the textiles.

It should also be noted that, according to the invention, a bond can be made between two textiles even if one or both of them carry thermoplastic products within the textile structure or as a result of a coating or resin impregnation treatment.

The invention achieves, inter alia:

A1—a saving of raw material, since better bonding results are obtained while using only half of the quantity of products currently used;

A2—a saving of time, since considerably higher operating speeds than the present ones are achieved;

A3—the manufacture of bonded products with improved characteristics of softness, feel, and fall, specific to textiles for clothing;

A4—the use of adhesives which permit washing or dry cleaning according to international standards and with excellent results.

The invention will be more clearly understood from the description and the attached drawing, which shows a practical and non-restrictive embodiment of the invention. In the drawing,

FIGS. 1, 2 and 3 show a prior solution described above;

FIG. 4 shows an adaptation of the machine of the known type shown in FIGS. 1 to 3, which is modified to enable the proposed process to be carried out;

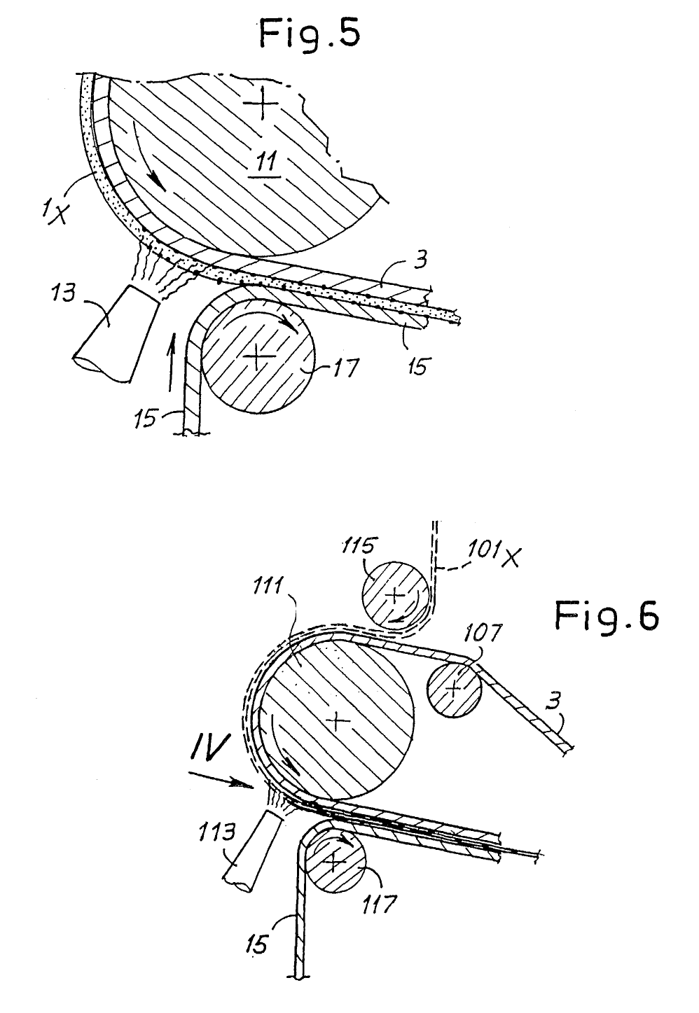

FIG. 5 shows a detail of FIG. 4 on a larger scale;

FIG. 6 shows a simplified version of the machine to implement the proposed process;

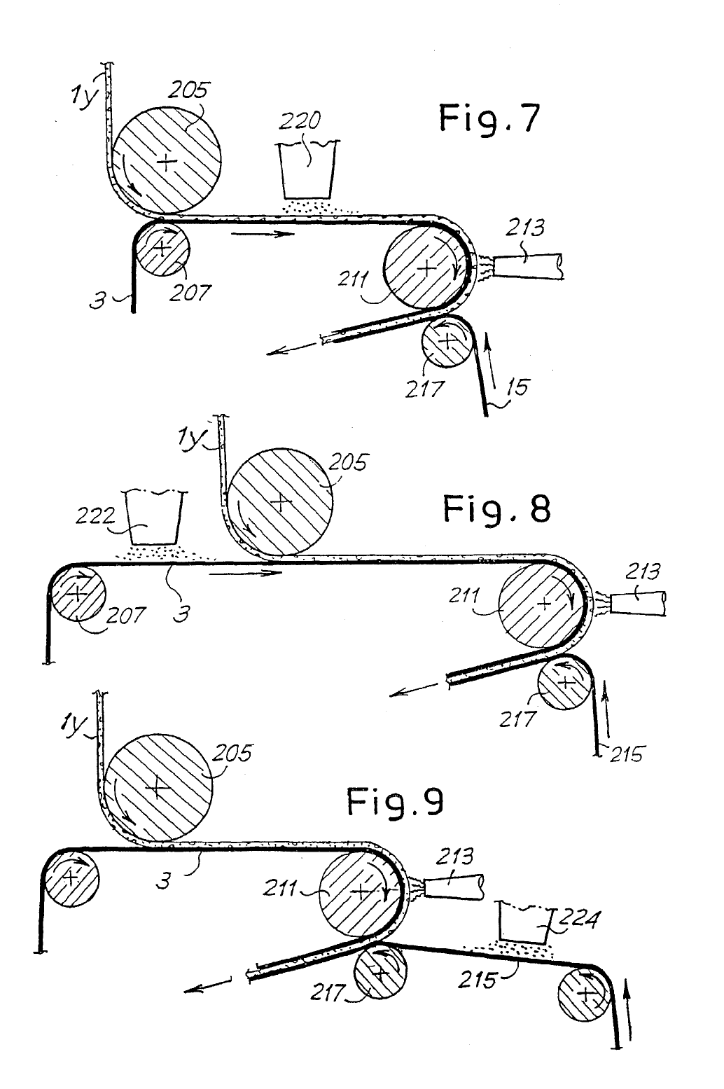

FIGS. 7, 8 and 9 show solutions in which adhesive is added to the hot melt.

In FIGS. 4 and 5 the components of the machine are identified by the same references used for the conventional solution shown in FIGS. 1 to 3. The modification consists in the removal of the first heating means 9, so that the hot-melt layer 1X is placed in the cold state on the first textile 3 and is carried by the latter to the second cylinder 11 where it is acted on by the heating means 13 which are in the proximity of the roller 17 around which runs the second textile 15 fed to said roller. The hot-melt layer, indicated by 1X in FIGS. 4 and 5, is very thin, and therefore the heating means 13 acting on it melt practically the whole of the thickness of said layer 1X, as far as the surface in contact with the textile 3, which is affected to a virtually negligible extent by the heating provided by the heating means 13, which can act directly on the very thin hot-melt layer 1X without causing appreciable increases in temperature in the first textile 3 as a result of the intensity of heating. Immediately after the thin hot-melt layer 1X has been melted, the second textile 15 is brought against the melted, i.e. plasticized, material of the layer 1X, and the two textiles 3 and 15 are bonded by the hot-melt material of the thin layer 1X as a result of the calender action between the cylinder 11 and the guides 17.

With this arrangement, only one heating means, namely that indicated by 13, is used, without the need to use the first heating means indicated by 9 in FIGS. 1 and 2. The use of a very thin layer, of expanded polyurethane for example, or of another hot-melt layer, for example a very thin cut film or foam (for example one of the types from the sources indicated above), is possible because of the transfer capacity provided by the textile 3 which receives the layer from the cylinder 5 and transfers it to the treatment area where the heating means 13 are located; the possible thinness of the hot-melt layer such as that indicated by 1X has the advantage of a saving of this hot-melt material (which is also relatively expensive), combined with a reduction in the quantity of the hot melt used per unit of surface area, providing the advantage of flexibility, softness and lightness in the bonded textile, which can thus also be used with very good results as a fabric for clothing, and not only for heavy upholstery.

FIG. 6 shows a variant of the conventional structure as modified in the solution shown in FIGS. 4 and 5. This variant has a single cylinder 111 (equivalent to the cylinder 11), a roller 115 for feeding the hot-melt layer 101X equivalent to 1X (the roller 115 being the equivalent of the cylinder 5), a roller 107 for feeding the textile 3, a single heating means 113 (equivalent to the means 13), and a roller 117 equivalent to the roller 17 for feeding the textile 15. With this solution, the structure of the machine is simplified, and therefore the overall dimensions of the machine are smaller than those of the conventional machine of FIGS. 1 to 3 and that of FIG. 4 modified according to the invention.

FIGS. 7, 8 and 9 show three diagrams of machines in which supplementary adhesives of the powder, paste or spray type are added to a thin layer of expanded hot melt. A powder dispenser device, normally of the sprinkler type, can be added. A dispenser device of the cylinder type with scraper cells can be used for the addition of supplementary adhesives in paste form. A spray dispenser can also be provided.

FIGS. 7, 8 and 9 show solutions in the form of machines in which supplementary adhesive dispensers are provided. In these solutions, the components 205, 207, 211, 213, 217 correspond to the components 5, 7, 11, 13, 17 of the preceding diagrams. FIG. 7 shows an adhesive dispenser 220 which supplements the hot melt 1Y placed on the first textile 3 with an adhesive which is acted on by the heating means 213. In the variant of FIG. 8, the adhesive is distributed on the textile 1 by a dispenser 222 before the hot melt 1Y is placed on the textile; in this case, the adhesive is exposed to the heating means through the hot melt. If the supplementary adhesive is not to be subjected to the action of the heating means, a dispenser 224 is arranged as shown in FIG. 9, to distribute the adhesive on the second textile 15, and comes into contact with the hot melt after the area of heating and melting of the hot melt.

It is to be understood that the drawing shows only an example provided solely as a practical demonstration of the invention, and that said invention can be varied in its forms and arrangements without departure from the scope of the guiding principle of the invention. The presence of any reference numbers in the attached claims has the purpose of facilitating the reading of the claims with reference to the description and to the drawing, and does not limit the scope of protection represented by the claims.

1. Process for bonding two textiles with a hot-melt layer, wherein a very thin hot-melt layer is applied on a first textile, said textile supporting and carrying the hot-melt layer in the cold state; said hot-melt layer is heated from the surface opposite the surface in contact with said first textile which supports and carries it, until the whole thickness of said layer is plasticized; and the second textile is then brought up to it and the two textiles are pressed together.

2. Process as claimed in claim 1, wherein the heating is provided by a flame.

3. Process as claimed in claim 1, wherein the heating is provided by hot air.

4. Process as claimed in at least one of the preceding claims, wherein said thin hot-melt layer is supplemented with auxiliary adhesives in powder and/or paste and/or spray form.

5. Process as claimed in claim 4, wherein said auxiliary adhesive is distributed on the hot melt layer placed on the first textile before the heating area.

6. Process as claimed in claim 4, wherein said auxiliary adhesive is distributed on the surface of the first textile before the hot melt layer is placed thereon.

7. Process as claimed in claim 4, wherein said auxiliary adhesive is distributed on the second textile.

8. Process as claimed in any one of the preceding claims, wherein the hot-melt layer is selected from the group including: a web, a sheet of foam, a film, a cut film.

9. Process as claimed in any one of the preceding claims, wherein the hot-melt layer is made of a material selected from the group including: polyester, polyamide, polyurethane, polyethylene,

10. Machine for bonding two textiles or similar products with a hot-melt layer, characterized in that it comprises means (5, 7; 111, 115) for bringing together in the cold state a first (3) of the two textiles (3, 15) and a very thin hot-melt layer (1X; 101X), in such a way as to cause said layer to advance together with said textile; a heating means (13; 113) which act on said hot-melt layer (1X; 101X) to plasticize it up to its surface in contact with said first textile (3); and means (11, 17; 111, 117) to bring the second textile (15) up to said plasticized hot-melt layer in contact with the first textile (3), and to press the two textiles (3, 15).

11. Machine as claimed in claim 10, characterized in that said heating means (13; 113) are positioned to act in the direction of an advancing cylinder (11; 111) on which is placed the first textile (3) which carries the hot-melt layer (1X, 101X); and in that, immediately after said heating means (13; 113) with respect to the advancing movement, there are roller means (17) or equivalent for bringing the second textile up to said plasticized hot-melt layer.

12. Machine as claimed in claim 10 or 11, characterized in that it comprises a first cylinder (11) and a first roller (7) which interact to bring together in the cold state the first textile (3) and the hot-melt layer (1X); a second cylinder (11) around which the first textile (3) supporting the hot-melt layer runs; the heating means (13) which act in the direction of said second cylinder (11); and, after said heating means (13), a second roller (17) interacting with. said second cylinder (11) to bring the second textile to bring the second textile (15) up to the first and to interact with the second cylinder (11) to press the two textiles and bond them.

13. Machine as claimed in claim 10 or 11, characterized in that it comprises a cylinder (111) and a first roller (115) interacting to bring the first textile (3) and the hot-melt layer (101X) together in the cold state, the first textile (3), which supports the hot-melt layer (101X), running around said cylinder (111); heating means (113) which act In the direction of said cylinder (111); and, after said heating means (113), a second roller (117) interacting with said cylinder (111) to bring the second textile (15) up to the first textile (3) and to press the two textiles and bond them.

14. Machine as claimed in at least one of claims 10 to 13, characterized in that it comprises a device for the addition of an auxiliary adhesive in the form of a powder and/or a paste and/or a spray.

15. Machine as claimed in claim 14, characterized in that said device is positioned to distribute the auxiliary adhesive over the hot melt placed on the first textile before the heating means.

16. Machine as claimed in claim 14, characterized in that said device is positioned to distribute the auxiliary adhesive over the surface of the first textile, before the hot melt is placed thereon.

17. Machine as claimed in claim 14, characterized in that said device is positioned to distribute the auxiliary adhesive over the second textile.
